(19) United States
(12) Patent Application Publication
(10) Pub. No.: US 2016/0158842 A1
(43) Pub. Date: Jun. 9, 2016

(54) Additive Manufacturing To Increase/Modify Equipment Operating Conditions

(71) Applicants: Nicholas F. URBANSKI, Katy, TX (US); Michael Matheidas, The Woodlands, TX (US)

(72) Inventors: Nicholas F. URBANSKI, Katy, TX (US); Michael Matheidas, The Woodlands, TX (US)

(21) Appl. No.: 14/955,260

(22) Filed: Dec. 1, 2015

Related U.S. Application Data
(60) Provisional application No. 62/087,660, filed on Dec. 4, 2014.

(51) Int. Cl. B22F 3/105; F04D 29/62; F04D 29/30; F04D 29/24; F04D 29/28; B23P 15/26; F04D 29/22

(52) U.S. Cl. CPC B22F 3/1055; B23P 15/26; F04D 29/624; F04D 29/628; F04D 29/225; F04D 29/24; F04D 29/284; F04D 29/30; B33Y 10/00

(57) ABSTRACT

A method, including: applying an additive manufacturing process to processing equipment, wherein the additive manufacturing process increases a dimension of the processing equipment and expands an operating envelope of the processing equipment.

### CROSS REFERENCE TO RELATED APPLICATIONS

This application claims the priority benefit of U.S. Patent Application 62/087,660 filed Dec. 4, 2014 entitled ADDITIVE MANUFACTURING TO INCREASE/MODIFY EQUIPMENT OPERATING CONDITIONS, the entirety of which is incorporated by reference herein.

### TECHNOLOGICAL FIELD

Exemplary embodiments described herein pertain to 3D printing/additive manufacturing. More specifically, some exemplary embodiments described herein apply 3D printing/additive manufacturing to change an operating envelope of processing equipment.

### BACKGROUND

This section is intended to introduce various aspects of the art, which may be associated with exemplary embodiments of the present invention. This discussion is believed to assist in providing a framework to facilitate a better understanding of particular aspects of the present invention. Accordingly, it should be understood that this section should be read in this light, and not necessarily as admissions of prior art.

Over the life of oil & gas assets, production decline and/or other changing conditions sometimes demand equipment to operate outside of its original design parameters. Retro-fits are often uneconomic due to the high cost of updated capital spares.

Various applications for centrifugal compression in oil/gas fields involve gas injection (produced gas, pressure maintenance, gas lift, etc.). As assets mature, available inlet pressure may decrease and/or injection pressure requirements increase, both of which require additional pressure producing capability across the compressor. Conventional solutions involve pre-investing in larger cases for later retro-fit with additional and/or larger impellers by changing the rotor. This permits the machine to maintain flow requirements and increase the pressure ratio. These compressor modifications can impose significant capital expense for new rotors and can be prohibitive. At times, this can be the limiting factor on the life of an asset.

U.S. Patent Application Publication 2014/0124483, the entire contents of which are hereby incorporated by reference, describes the concept of using additive manufacturing to add structural members. This patent application fails to disclose anything regarding process equipment or extending the operating envelope of that processing equipment. This patent application pertains to adding more parts to an existing structure as opposed to increasing dimensions of existing parts.

International Patent Application Publication WO 2014/095208, the entire contents of which are hereby incorporated by reference, describes using a rotating device to print parts as opposed to planar systems. This publication does not describe adding additional material to certain existing types of process equipment to extend their operating envelope.

Additional background information may be found in U.S. Pat. No. 7,832,457, U.S. Patent Applications 2014/0205454A1, 2014/0163717A1, 2014/0154088A1, 2014/0124483A1, 2013/0310961A1, 2013/0320598A1, 2013/0316183A1, and 2013/0149182A1, and European Patent Application 2675583A2, each of which is hereby incorporated by reference in their entirety.

### SUMMARY

A method, including: applying an additive manufacturing process to processing equipment, wherein the additive manufacturing process increases a dimension of the processing equipment and expands an operating envelope of the processing equipment.

The processing equipment can include a rotor, and the method can further include: removing the rotor from a housing; and disposing the rotor in an additive manufacturing location.

The processing equipment can have been employed in an industrial process prior to the applying of the additive manufacturing process.

The method may further include: returning the rotor, with the expanded operating envelope, to use in the industrial process.

The operating envelope can be expanded by using the additive manufacturing process to enlarge diameters of impellers on the rotor.

The enlarged impellers can change a performance capability of the processing equipment.

The performance capability can be a head producing capability.

The processing equipment can be a rotor with an impeller or duplicity of impellers.

The additive manufacturing process can include increasing an outer diameter of an impeller or duplicity of impellers of the rotor.

The processing equipment can be a centrifugal compressor.

The processing equipment can be a centrifugal pump.

The method can include applying a subtractive process to remove existing impeller material from the processing equipment, and applying the additive manufacturing process to add material with a different physical attribute to the processing equipment, which changes a performance characteristic of the processing equipment.

The method can include changing an angle of an impeller vane or adding channels or physical features to an impeller vane or inside surface of a cover of the processing equipment.

The processing equipment can be a heat exchanger.

The processing equipment can be a core of a plate frame heat exchanger.

The additive manufacturing processes can be used to increase a dimension of the core of the plate frame heat exchanger.

The additive manufacturing process can include directly printing a plate onto the core.

### BRIEF DESCRIPTION OF THE DRAWINGS

While the present disclosure is susceptible to various modifications and alternative forms, specific example embodiments thereof have been shown in the drawings and are herein described in detail. It should be understood, however, that the description herein of specific example embodiments is not intended to limit the disclosure to the particular forms disclosed herein, but on the contrary, this disclosure is to cover all modifications and equivalents as defined by the appended claims. It should also be understood that the drawings are not necessarily to scale, emphasis instead being placed upon clearly illustrating principles of exemplary embodiments of the present invention. Moreover, certain dimensions may be exaggerated to help visually convey such principles.

FIG. 1 is an exemplary method for extending the operating envelope for an impeller device;

FIG. 2 is an exemplary rotor device and 3D print head;

FIG. 3 is an exemplary exploded view of a welded plate frame heat exchanger; and

FIG. 4 is an exemplary method for extending the operating envelope for a heat exchanger.

### DETAILED DESCRIPTION

Exemplary embodiments are described herein. However, to the extent that the following description is specific to a particular, this is intended to be for exemplary purposes only and simply provides a description of the exemplary embodiments. Accordingly, the invention is not limited to the specific embodiments described below, but rather, it includes all alternatives, modifications, and equivalents falling within the true spirit and scope of the appended claims.

The present technological advancement can capture technology opportunities through the use of additive manufacturing as a technique to change equipment operating envelopes. The present technological advancement provides an alternative solution to the problem described above and avoids the problem of expensive retrofits. Some exemplary embodiments described herein add additive manufacturing technology (e.g., direct metal laser sintering or equivalent additive 3D printing) to an existing compressor/pump assembly as a way to increase the diameter of an impeller without replacing the rotor/bundle.

The present technological advancement can expand the operating envelope of an impeller by increasing the impeller diameter, which obviates the need to purchase new impellers/rotor. The cost to increase the pressure producing capability of the compressor could be substantially lower than purchasing new equipment and be an enabler to cost effectively extending the life of a process equipment. A similar solution can be implemented for centrifugal pump impellers/rotors (including, but not limited to horizontal multi-stage, horizontal over-hung, single stage vertical) where field conditions require higher head or higher delta pressure (DP) conditions. This solution would be used in lieu of purchasing new modified impellers.

As used herein, additive manufacturing means a process performed with three-dimensional printing equipment, where successive layers of material are laid down to form a three-dimensional structure. Exemplary 3D printing techniques include, but are not limited thereto, scanning laser epitaxy and direct metal laser sintering (DMLS).

As used herein, operating envelope means an initial limited range for a design parameter(s) of piece of equipment in which operations will result in safe and acceptable equipment performance. Any number of parameters can be used to define the operating envelope for the piece of equipment.

As used herein, process or processing equipment is equipment which uses physical or chemical methods to at least one of transport or alter a raw material or product.

Exemplary embodiments discussed herein pertain to centrifugal compressor and pump impellers, and heat exchangers. However, the present technological advancement is not necessarily limited to this exemplary processing equipment, and may be adapted or applied to change the operating envelopes of other equipment.

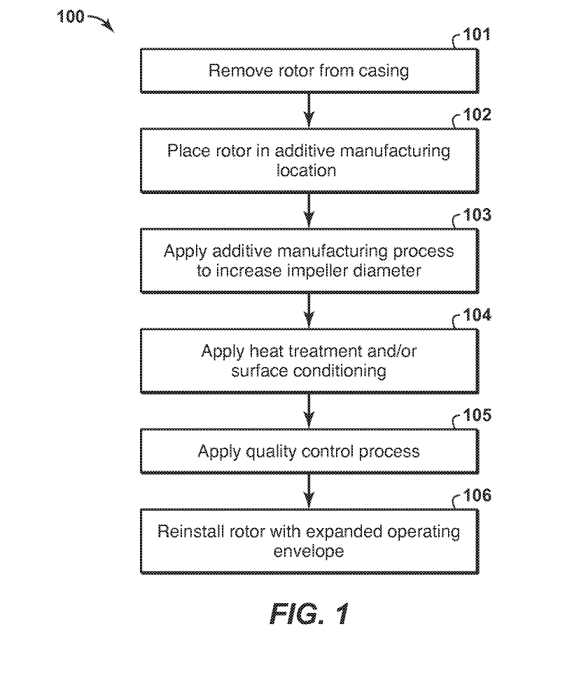

FIG. 1 is an exemplary method 100 for extending the operating envelope for processing equipment. In step 101, a rotor is removed from its casing. In some embodiments, the rotor has been used (i.e., employed in an industrial process) in a centrifugal compressor, and the current operating conditions have changed such that the operating envelope of the rotor is no longer suitable for the current operating conditions.

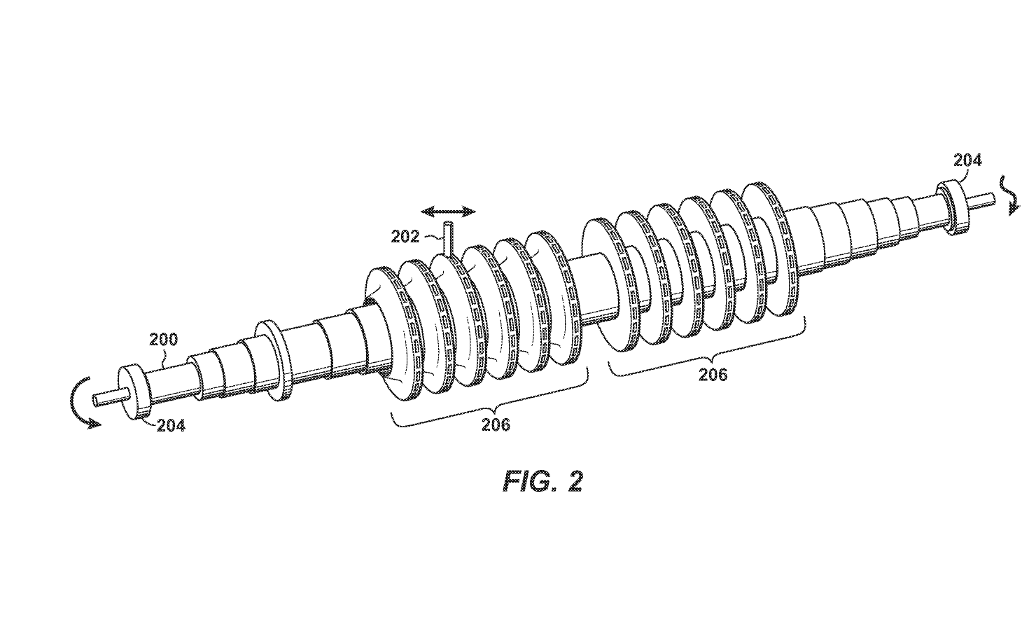

In step 102, the rotor is placed in a suitable fixture which permits access by the printing device and controls the rotation of the rotor. In this embodiment, changes to the processing equipment are not done in situ. However, other embodiments can apply the present technological advancement to processing equipment in situ (e.g., it is still in the original casing at the location where it normally functions). A suitable additive manufacturing location can include equipment to apply additive manufacturing to the processing equipment and can include an inert gas environment. As shown in FIG. 2, for example, the manufacturing location includes a 3D print head 202 disposed to add material to the outer diameter of impellers 206 and a station 204 to hold and rotate the rotor 200 as the print head is moved in a lateral direction. The station 204 that holds the impellers 206 could have the impellers 206 disposed on a spare rotor. While not shown, conventional additive manufacturing components control the positioning and actuation of the 3D print head.

In the additive manufacturing location, a computer can control the rotor 200 to turn slowly and evenly enough to meet the deposition limits of the additive manufacturing process (e.g., DMLS) onto the impellers. Access to the surface of the drive shaft can be provided for an external belt or equivalent drive system with a digital feedback control loop for shaft position. The computer can control shaft position in conjunction with the lateral position and speed of the 3D print head. Those of ordinary skill in the art could employ existing configurations and operations to implement the joint control of the shaft rotation and print head position. For example, processes of controlling the location of the print head 202 and rotation of the rotor 200 are well within known manufacturing processes for CNC (computer numerically controlled) machining.

In step 103, an additive manufacturing process is applied to the impeller (e.g., DMLS), which provides an additional layer of material on the blades and cover(s) of the impeller to increase the outer diameter. The height of the addition may be determined based on a difference between a desired operating characteristic and a current operating characteristic, as limited by the diameter of the impeller housing. For example, the added height can be as little as <1″ or as much as several inches. The added height can depend on a maximum allowable stress and clearance within the existing housing. In lieu of purchasing new rotors or impellers, externally mounted DMLS (or equivalent) systems (laser beam combined with a form of thin-layer metal powder distribution) are attached or positioned to permit printing additional material on the outer diameter of the impellers 206.

For example, in this embodiment, enlargement of the operating envelope is accomplished via larger impeller diameters that increase the performance capability and performance characteristics of a processing machine. In this case, increasing diameter of centrifugal impellers increases the head producing capability (i.e. more delta pressure). The outer diameter of the blades can be enlarged beyond the manufacturer's original specifications to increase the pressure generated by the impeller. Increasing the outer diameter of a compressor impeller increases the tip speed at a given RPM, which increases the head producing capability of the impeller and a corresponding increase in delta pressure (DP) across the machine. The effect is compounded across the machine for each wheel.

The present technological advancement can be used in combination with a subtractive process. For example, a subtractive process (e.g. machining, grinding, and cutting) can be used to remove material in combination with the additive manufacturing process to further change the physical design and performance characteristics of the impeller(s). Examples could include changing the angle of the impeller vane, adding channels or physical features on the vanes and inside surfaces of the cover, etc.

In step 104, a heat treatment and/or surface conditioning (e.g. skimming, machining to improve surface roughness, etc.) is applied as necessary to meet required material properties. The heat treatment can be applied together with surface conditioning. The heat treatment can be applied with a heat unit, which can include one or more of lasers or heaters.

In step 105, a quality control process can be implemented to ensure that the additive manufacturing process applied to the impeller results in an impeller with a new operating envelope that provides for the desired operating characteristic. Quality control tests can include, but are not limited thereto, dimensional testing and overspeed testing.

In step 106, the impeller, having its changed operating envelope, is reinstalled and placed back into operation.

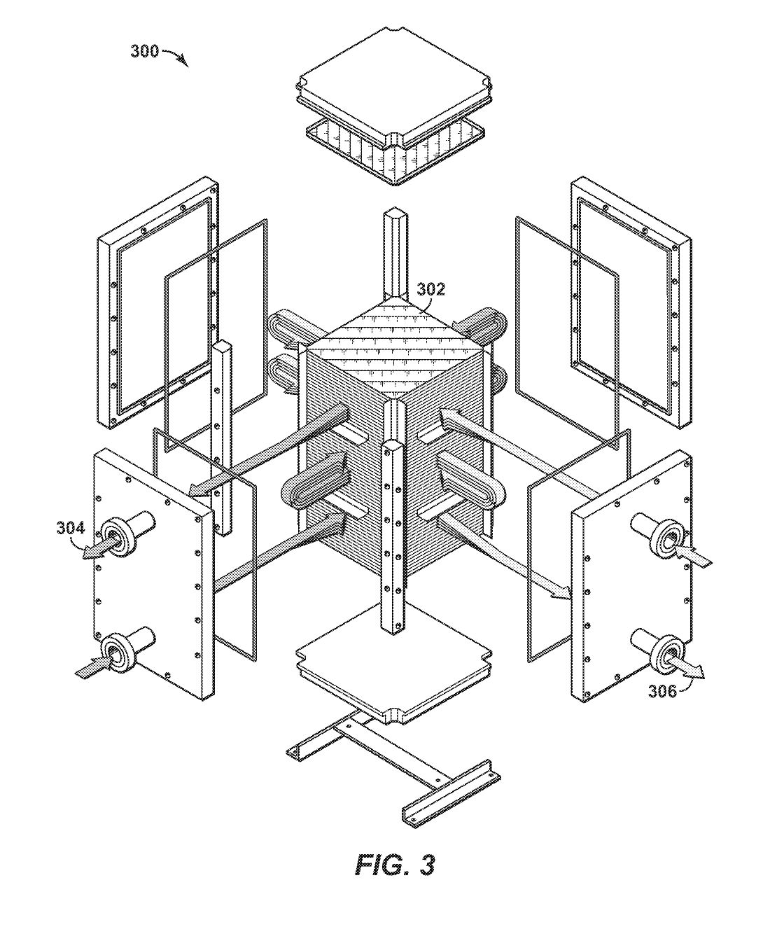

FIG. 3 is an exemplary exploded view of a welded plate frame heat exchanger 300. Heat exchanger 300 includes core 302 and various frame and housing components. The core 302 includes a plurality of metal plates that are configured to transfer heat between fluids 304 and 306. The metal plates are compressed together in a rigid frame to form an arrangement of parallel flow channels with alternating hot fluids 304 and cold fluids 306. The metal plates can be corrugated plates with intermating and chevron corrugations.

In a plate frame heat exchanger, the fluids are exposed to a large surface area that facilitates heat transfer because the fluids are spread out over the plates. The operating envelope of the plate frame heat exchanger 300 can be expanded by adding more metal plates to the core 302. The present technological advancement can utilize an additive manufacturing process to increase surface area of in-situ equipment, specifically for welded plate frame exchangers (PFE). With respect to welded plate frame exchangers (PFEs), additive manufacturing (e.g. DMLS) is used as a method to add plates (layers) of similar design to the top of the core, extending its height, and effective heat transfer surface area without fabricating a whole new core/unit. The DMLS process would also take into consideration the fluid partition plates (extensions from the core around which fluid is redirected from one pass to another).

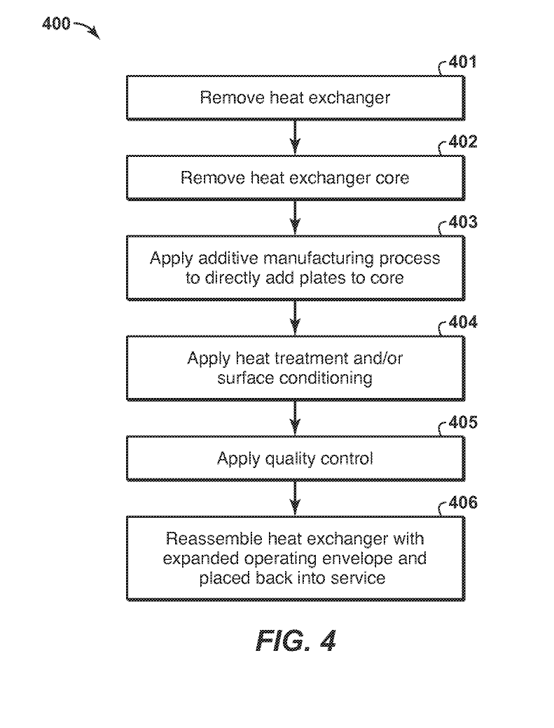

FIG. 4 is an exemplary method 400 for extending the operating envelope for a heat exchanger.

In step 401, the heat exchanger is removed from service and disassembled. In step 402, the heat exchanger core is removed. In step 403, an additive manufacturing process (e.g., DMLS) is used to fabricate additional plates to the core (i.e., increase the dimensions of the core) and new housing and associated structures (e.g., internal pass partition plates) to accommodate a newly dimensioned core (i.e., the core with more plates). The additional plates can be directly printed on the existing core of the welded plate frame heat exchanger. The height of the addition may be determined based on the difference between a desired operating characteristic and a current operating characteristic, as limited by the dimensions of the installed housing. In some embodiments, a subtractive process can be used to remove material in combination with the additive process.

In step 404, a heat treatment or surface conditioning is applied as necessary. The heat treatment can be applied together with surface conditioning. The heat treatment can be applied with a heat unit, which can include one or more of lasers or heaters.

In step 405, a quality control process can be implemented to ensure that the additive manufacturing process applied to the heat exchanger results in a heat exchanger with a new operating envelope that provides for the desired operating characteristic. Quality control tests can include, but are not limited thereto, dimensional testing and pressure/hydro testing.

In step 406, the heat exchanger, having its new enlarged operating envelope, is reassembled in a new housing and placed back into service.

The above examples describe how the present technological advancement can expand the operating envelope of processing equipment. The present technological advancement is not merely repairing processing equipment. A repair is nothing more than restoring damaged equipment to manufacturer's specification. The present technological advancement, on the contrary, deliberately modifies the processing equipment to expand the operating envelope, which can be accomplished by increasing a dimension of a component of the processing equipment through an application of additive manufacturing.

Additionally, the present technological advancement can be implemented via computer instructions stored on a non-transitory computer readable storage medium.

The present techniques may be susceptible to various modifications and alternative forms, and the examples discussed above have been shown only by way of example. However, the present techniques are not intended to be limited to the particular examples disclosed herein. Indeed, the present techniques include all alternatives, modifications, and equivalents falling within the spirit and scope of the appended claims.

What is claimed is:

1. A method, comprising:
applying an additive manufacturing process to processing equipment, wherein the additive manufacturing process increases a dimension of the processing equipment and expands an operating envelope of the processing equipment.

2. The method of claim 1, wherein the processing equipment includes a rotor, and the method further comprises:
removing the rotor from a housing; and
disposing the rotor in an additive manufacturing location.

3. The method of claim 1, wherein the processing equipment had been employed in an industrial process prior to the applying of the additive manufacturing process.

4. The method of claim 3, further comprising:
returning the rotor, with the expanded operating envelope, to use in the industrial process.

5. The method of claim 4, wherein the operating envelope is expanded by using the additive manufacturing process to enlarge diameters of impellers on the rotor.

6. The method of claim 5, wherein the enlarged impellers change a performance capability of the processing equipment.

7. The method of claim 6, wherein the performance capability is a head producing capability.

8. The method of claim 1, wherein the processing equipment is a rotor with an impeller or duplicity of impellers.

9. The method of claim 2, wherein the additive manufacturing process includes increasing an outer diameter of an impeller or duplicity of impellers of the rotor.

10. The method of claim 1, wherein the processing equipment is a centrifugal compressor.

11. The method of claim 1, wherein the processing equipment is a centrifugal pump.

12. The method of claim 1, wherein the method includes applying a subtractive process to remove existing impeller material from the processing equipment, and applying the additive manufacturing process to add material with a different physical attribute to the processing equipment, which changes a performance characteristic of the processing equipment.

13. The method of claim 12, wherein the method includes changing an angle of an impeller vane or adding channels or physical features to an impeller vane or inside surface of a cover of the processing equipment.

14. The method of a claim 1, wherein the processing equipment is a heat exchanger.

15. The method of claim 1, wherein the processing equipment is a core of a plate frame heat exchanger.

16. The method of claim 15, wherein the additive manufacturing processes increases a dimension of the core of the plate frame heat exchanger.

17. The method of claim 15, wherein the additive manufacturing process includes directly printing a plate onto the core.
